(19) United States
(12) Patent Application Publication
(10) Pub. No.: US 2026/0273887 A1
(43) Pub. Date: Sep. 17, 2026

(54) PACKAGE BOX CONTAINING BUFFER-FORMING CORE FOR FORMING BUFFER PACKING MATERIAL

(71) Applicants: Wei Wen PENG, Sugar Land, TX (US); Jui-Chun CHANG, Sugar Land, TX (US)

(72) Inventor: Wei Wen PENG, Sugar Land, TX (US)

(21) Appl. No.: 19/417,076

(22) Filed: Dec. 11, 2025

Related U.S. Application Data
(63) Continuation-in-part of application No. PCT/US25/19444, filed on Mar. 11, 2025.

(51) Int. Cl. B31D 3/02; B31D 3/04; B31D 5/00; B65D 85/67

(52) U.S. Cl. CPC B31D 3/0292; B31D 3/04; B31D 5/0069; B65D 85/67; B31D 2205/0035

(57) ABSTRACT

A package box containing a buffer-forming core for forming a buffer packing material. The buffer packing material includes a plurality of identical belt-shaped sheets bonded to one another at bonded parts of the sheets and expanded in an expansion axis, and the buffer-forming core is composed of the sheets stacked in the expansion axis direction. The package box includes a conveyance path constituted by a wide path and a narrow path which includes a constriction part, and at an open position, by pulling out the buffer-forming core stored in the package box through a discharge port of the discharge compartment, the buffer-forming core is expanded to form the packing material for use. At a closed position, the package box becomes a rectangular parallelepiped box which is compact and easy to store, ship, carry, and use.

### BACKGROUND OF THE INVENTION

### Field of the Invention

The present invention generally relates to a package box containing a buffer-forming core for forming a buffer packing material.

### Description of the Related Art

A buffer packing material is provided for filling spaces between a box and objects contained in the box to protect the objects from being hit or damaged during transportation. In recent years, the logistics industry has been booming, and logistics-related industries such as the manufacture of buffer packing materials are also flourishing.

Existing buffer packing materials generally include two types: inflatable plastic film and honeycomb. Due to environmental protection issues, plastic-reduced packaging materials are bound to be the key point of future development.

In recent years, paper-based buffer packing materials have gradually become popular because they can better adapt to environmental requirements in terms of decomposition and disassociation.

For example, PCT Publication No. WO2025/226362 discloses a buffer-forming core made for forming a buffer packing material shaped and formed by expanding the buffer-forming core, comprising a plurality of belt-shaped sheets each extending in a widthwise direction, the sheets stacked in a lengthwise direction perpendicular to the widthwise direction, wherein each sheet has a plurality of bonded parts and a plurality of non-bonded parts arranged alternately in the widthwise direction, the bonded parts of each sheet, except a top sheet and a bottom sheet in an expansion direction, are composed of first bonded parts and second bonded parts arranged alternately in the widthwise direction, wherein the first bonded parts of the sheet are bonded to the second bonded parts of an adjacent sheet, whereas the second bonded parts of the sheet are bonded to the first bonded parts of another adjacent sheet. PCT Publication No. WO2025/226362 also discloses a buffer packing material-forming machine for forming the buffer packing material. The sheets have top and bottom sections in the height direction, wherein the top and bottom sections are bent with respect to the height direction so as to form bend-deformed edges which prevent the expanded buffer packing material from returning to its original non-expanded state. In order to form the bend-deformed edges, the machine uses a rolling unit to form the top and bottom having bend-deformed edges when expanding the sheet in a conveying direction.

However, installing such a machine is costly and is not suitable for small businesses owners who want to pack objects easily and inexpensively for shipping.

An object of the present disclosure is to expand a buffer-forming core in a conveying direction which is the lengthwise direction of the buffer-forming core to form the roughly hexagonal honeycomb bodies, without using a machine. Another object of the present disclosure is to easily and quickly expanding the buffer-forming core and cut it in a desired length at any site where packing is taking place, so that the object(s) can be secured using the expanded buffer-forming core quickly, as a buffer packing material without the top and bottom bend-formed edges.

Any discussion of problems and solutions in relation to the related art has been included in this disclosure solely for the purposes of providing a context for the present invention, and should not be taken as an admission that any or all of the discussion was known at the time the invention was made.

### SUMMARY OF THE INVENTION

Some embodiments provide a package box containing therein a buffer-forming core for forming a buffer packing material, wherein
the buffer-forming core is composed of a plurality of identical belt-shaped sheets bonded to one another at bonded parts of the sheets and is expandable in an expansion axis to form a buffer packing material, wherein the bonded parts are positioned so that, at an expanded state, the sheets form roughly hexagonal honeycomb bodies as viewed in a height direction perpendicular to the expansion axis, and
the package box comprises:
a storage compartment in which the belt-shaped sheets are stacked and stored; and
a discharge compartment which is disposed on top of the storage compartment at a closed position as a lid of the storage compartment when in non-use, wherein the discharge compartment pivots on a first rim of the storage compartment and flips by pivoting on the first rim at an open position when in use, said discharge compartment comprising: a feeding port (a feeding opening) proximal to the first rim for guiding and feeding the buffer-forming core stored in the storage compartment in a direction of the expansion axis; a discharge port (a discharge opening) distal to the first rim, disposed at an edge opposite to the feeding port, for outputting the buffer packing material; and a conveyance path for passing the buffer-forming core therethrough from the feeding port to the discharge port in the direction of the expansion axis; wherein
the conveyance path has a constriction part wherein at the open position, by pulling the belt-shaped sheet(s) at the discharge port out of the discharge port, the buffer-forming core, while being conveyed through the conveyance path, is expanded through the constriction part in a conveying direction which is the direction of the expansion axis of the buffer-forming core to form the roughly hexagonal honeycomb bodies.

In some embodiments, the buffer-forming core is replaceable, and when the buffer-forming core is finished, a new buffer-forming core can be loaded to the package box.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a schematic perspective view of the package box in use at an open position according to an embodiment of the present invention, wherein broken lines indicate the shape of the conveyance path provided in the discharge compartment as viewed from above.

FIG. 2 is a schematic partial perspective view of the package box shown in FIG. 1 in use at the open position according to an embodiment of the present invention, wherein broken lines indicate the inside general structure of the discharge compartment in a perspective view (in order to show the general structure of the discharge compartment, the buffer-forming core passing therethrough is omitted inside the discharge compartment).

FIG. 3 is a schematic perspective view of the package box after tearing off a buffer packing material according to an embodiment of the present invention, wherein broken lines indicate the shape of the conveyance path provided in the discharge compartment as viewed from above.

FIG. 4 is a schematic perspective view of the package box after use according to an embodiment of the present invention, when the discharge compartment is folded back to the original position (the closed position).

FIG. 5 is a schematic perspective view of the package box after use according to an embodiment of the present invention, when the outer lid also is closed at the closed position, forming a rectangular parallelepiped box.

FIG. 6 is a schematic perspective view showing a buffer-forming core in the state before expanding and forming in accordance with an embodiment of the present disclosure.

FIG. 7 is an image of the package box corresponding FIG. 3, showing a part of the storage compartment disassembled to reveal the interior where a layer of the stacked sheets of the buffer-forming core is stored in a serpentine pattern.

### DETAILED DESCRIPTION OF EMBODIMENTS

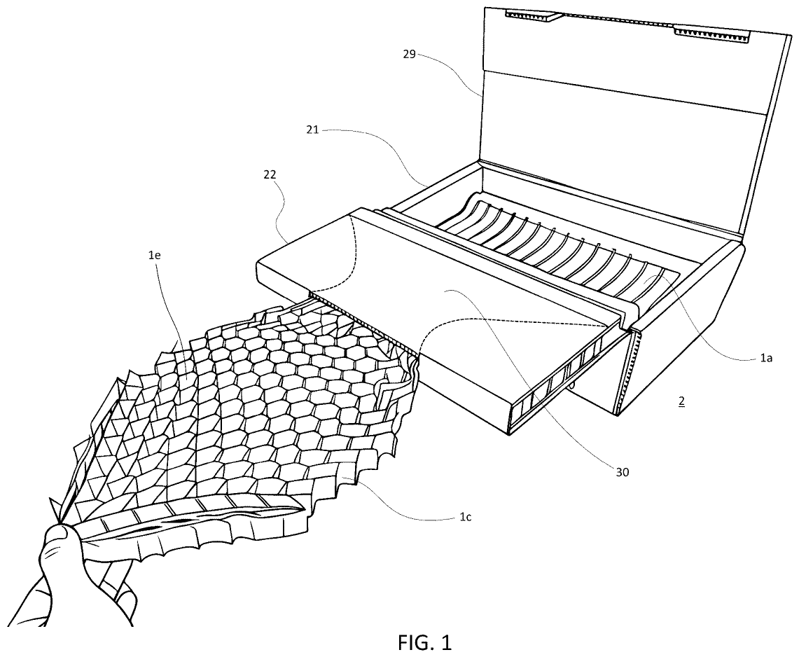

The present inventions are explained in detail below using specific embodiments; however, the inventions are not limited to the disclosed embodiments and include any equivalents. In this disclosure, “the invention/disclosure” or “the present invention/disclosure” may refer collectively to at least one of the embodiments or examples explicitly or inherently disclosed herein. Further, in all of the disclosed embodiments, any element used in an embodiment can interchangeably or additionally be used in another embodiment unless such a replacement is not feasible or causes adverse effect or does not work for its intended purposes. Additionally, it should be noted that similar components are referred to by the same number in the following description. It should also be noted that the numbers/symbols/explanations in parentheses indicate corresponding features of the illustrated embodiments of FIGS. 1-6, to illustrate support rather than to limit the invention to these embodiments.

Some embodiments provide as a fist aspect:
<1> A package box (2) containing therein a buffer-forming core (1, 1a) for forming a buffer packing material (1c), wherein the buffer-forming core (1, 1a) is composed of a plurality of identical belt-shaped sheets (10) bonded to one another at bonded parts (11a, 11b) of the sheets and is expandable in an expansion axis (X) to form a buffer packing material (1c), wherein the bonded parts (11a. 11b) are positioned so that, at an expanded state, the sheets (10) form roughly hexagonal honeycomb bodies (1e) as viewed in a height direction perpendicular to the expansion axis (X), and

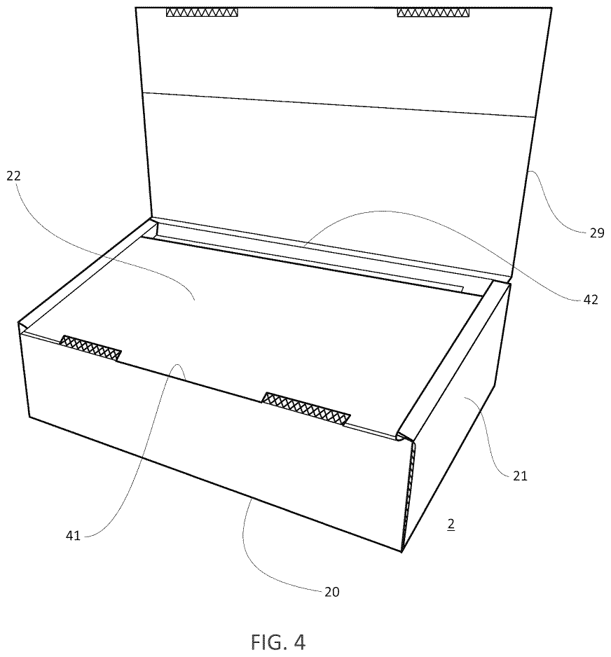

The package box (2) comprises:
a storage compartment (21) in which the belt-shaped sheets (10) are stacked and stored; and
a discharge compartment (22) which is disposed on top of the storage compartment (21) at a closed position as a lid of the storage compartment (21) when in non-use, wherein the discharge compartment (22) pivots on a first rim (41; FIG. 4) of the storage compartment (21) and flips by pivoting on the first rim (41) at an open position when in use, said discharge compartment (22) comprising: a feeding port (24) proximal to the first rim (41) for guiding and feeding the buffer-forming core (1a) stored in the storage compartment (21) in a direction of the expansion axis (X); a discharge port (23) distal to the first rim (41), disposed at an edge opposite to the feeding port (24), for outputting the buffer packing material (1c); and a conveyance path (30) for passing the buffer-forming core (1b) therethrough from the feeding port (24) to the discharge port (23) in the direction of the expansion axis (X); wherein the conveyance path (30) has a constriction part (33, also referred to as “a neck port”) wherein at the open position, by pulling the belt-shaped sheet(s) (10, 10a) at the discharge port (23) out of the discharge port (23), the buffer-forming core (1c), while being conveyed through the conveyance path (30), is expanded through the constriction part (33) in a conveying direction (X) which is the direction of the expansion axis (X) of the buffer-forming core (1c) to form the roughly hexagonal honeycomb bodies (1e).

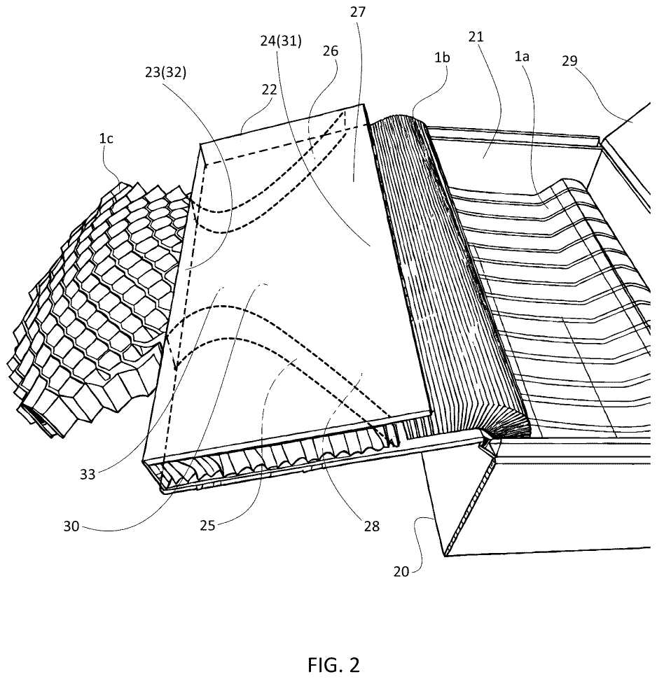

FIG. 1 is a schematic perspective view of the package box in use according to an embodiment of the present invention, wherein broken lines indicate the shape of the conveyance path provided in the discharge compartment as viewed from above. FIG. 2 is a schematic partial perspective view of the package box shown in FIG. 1 in use according to an embodiment of the present invention, wherein broken lines indicate the inside general structure of the discharge compartment in a perspective view (in order to show the general structure of the discharge compartment, the buffer-forming core passing therethrough is omitted inside the discharge compartment).

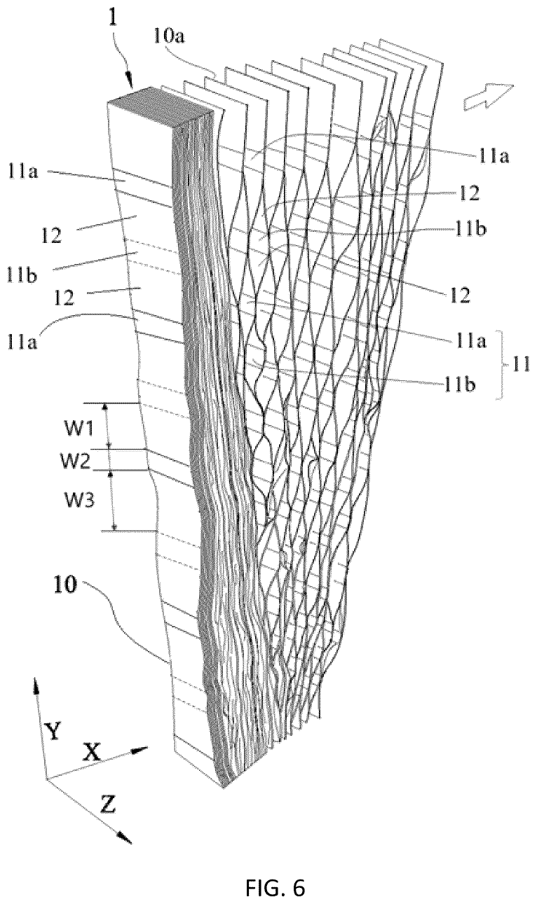

In some embodiments, as the belt-shaped sheet(s), those disclosed in PCT Publication No. WO2025/226362 (illustrated in FIG. 6 of the instant application) can be used, the disclosure of which is hereby incorporated by reference in its entirety.

In order to form a proper buffer packing material, the shape of a roughly hexagonal honeycomb body may be adjusted. The shape of a roughly hexagonal honeycomb body can be defined by determining a ratio of a length of a bonded part and a length of a non-bonded part of the roughly hexagonal honeycomb body, i.e., W2/(W1+W3) wherein W1 is a length of a non-bonded part (12) of a sheet between the bonded part (11a) bonding to an adjacent sheet on one side of the sheet and the bonded part (11b) bonding to an adjacent sheet on the other side of the sheet in the widthwise direction (Y), W2 is a length of a bonded part (11a), and W3 is a length of the other non-bonded part (12) wherein the bonded part (11a) is sandwiched between the non-bonded part (12) and the other non-bonded part (12) (see FIG. 9 wherein the bonded part (11a), which bonds the sheet and an adjacent sheet on a back side of the sheet, is shown by solid lines, whereas the bonded part (11b), which bonds the sheet and an adjacent sheet on a front side of the sheet, is shown by broken lines. In some embodiments, a ratio of W2/(W1+W3) is 5% or greater and 60% or less, preferably 10% or greater but no greater than 50%.

In some embodiments, the sheet of the buffer-forming core is made of a fiber material selected from about 80 g/m² to about 200 g/m², with a thickness of about 0.08 mm to about 0.2 mm, a width of about 10 cm to about 80 cm along the horizontal axis, a height of about 1 cm to about 6 cm along the vertical axis, and the spacing of the bonded part between every two sheets is about 0.5 cm to about 5 cm. In some embodiments, there is no restriction imposed on the dimensions of the buffer-forming core, and can be selected depending on the intended use (e.g., the size, shape, and/or fragility of the objects to be cushioned or protected during shipping and/or while in a storage).

The conveyance path (30) has the constriction part (33) in a manner that the width of the conveyance path is changed gradually (e.g., constituted by curved lines or a combination of straight lines and curved lines therebetween) or stepwise in the conveyance direction, wherein the width of the constriction part is smallest.

The first aspect includes <2> the conveyance path (30) wherein the conveyance path (30) is defined by an upper plate (27), a lower plate (28), a first side wall (25), and a second side wall (26), wherein the first side wall (25) and the second side wall (26) are shaped in a manner that the conveyance path (30) comprises a wide path (31) proximal to the feeding port (24) and a narrow path (32) proximal to the discharge port (23), said narrow path (23) including the constriction part (33), wherein, in a longitudinal direction of the belt-shaped sheets (10, 10a), a width of the wide path (31) at the feeding port (24) is greater than a width of the narrow path (32) at the discharge port (23), and a width of the constriction part (33) is smallest in the conveyance path.

In some embodiment, the first and second side walls (25, 26) may be continuous or discontinuous in the conveyance direction. For example, the first and second side walls (25, 26) can be formed by using a cardboard strap wound roughly in a spiral shape and secured in place on surfaces of the upper and lower plates (27, 28) using an adhesive.

The first aspect includes <3> the package box (2) wherein the storage compartment (21) is a top-less rectangular parallelepiped container, and the discharge compartment (22) acts as a lid (22; FIG. 4) of the storage compartment (21) at the closed position and flips by pivoting on the first rim (41) at the open position.

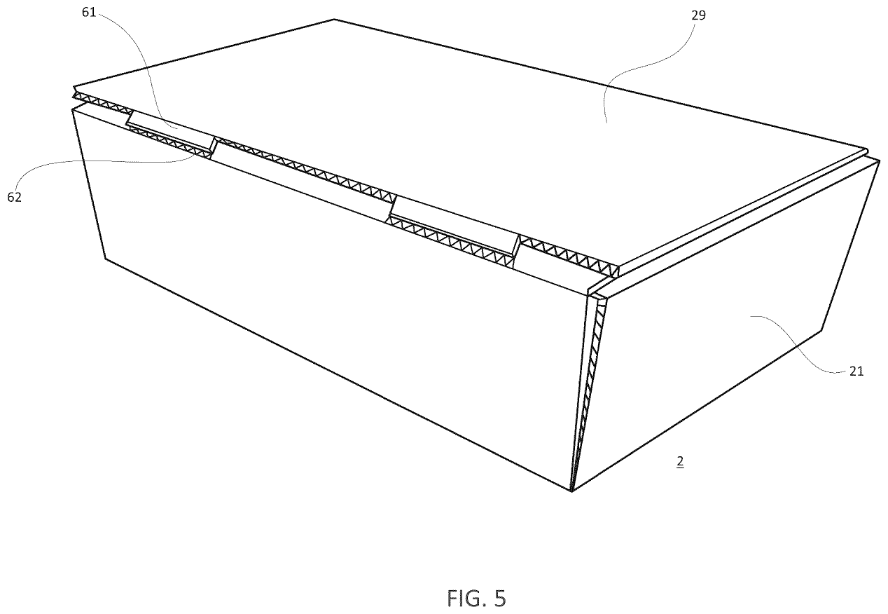

The first aspect includes <4> the package box (2) further comprising an outer lid (a top lid) (29; FIG. 4) which is attached to a second rim (42; FIG. 4) of the storage compartment (21) opposite the first rim (41) at the closed position, and flips by pivoting on the second rim (42) at the open position, wherein the discharge compartment (22) acts as an inner lid. In some embodiments, the outer lid is not necessary and is not included, and at the closed position, the package box (2) becomes a rectangular parallelepiped box which is compact and easy to carry. FIG. 4 is a schematic perspective view of the package box after use according to an embodiment of the present invention, when the discharge compartment (21) is folded back to the original position (the closed position), and FIG. 5 is a schematic perspective view of the package box after use according to an embodiment of the present invention, when the outer lid (29) is closed at the closed position, forming a rectangular parallelepiped box, where the outer lid (29) has two tongues (31) which are inserted into slots (32) so as to close properly. In this form, the package box can be shipped securely.

The first aspect includes <5> the package box (2) wherein the storage compartment (21) and the discharge compartment (22) are made of cardboard. In some embodiments, they are made of hard paper, corrugated fiber board, etc., commonly used in the industry.

The first aspect includes <6> the package box (2) wherein the storage compartment (21) is made of cardboard, and the discharge compartment (22) is made of plastic. When the discharge compartment (22) is made of plastic, the first and second side walls (25, 26) and the upper and lower plates (27, 28) can be formed integrally by, e.g., integral molding. The material of the first and second side walls and the material of the upper and lower plates can be the same or different and can be any suitable material including those conventionally known, as long as the position of the first and second side walls is secured and fixed. In some embodiments, the material of the first and second side walls may be stronger and/or thicker than that of the upper and lower plates.

The first aspect includes <7> the package box (2) wherein a distance between the upper plate and the lower plate of the conveyance path (30) corresponds substantially to a height of the buffer-forming core (1b). If the distance is smaller than the height of the buffer-forming core, the top and bottom sections of the buffer-forming core may be deformed as being discharged from the discharge port (23), wherein the top and bottom sections are bent with respect to the height direction so as to form bend-deformed edges which prevent the expanded buffer packing material from returning to its original non-expanded state as described in PCT Publication No. WO2025/226362.

The first aspect includes <8> the package box (2) wherein the width of the narrow path (32) at the discharge port is about 40% to about 80% (typically 50% or less) of the width of the wide path (31) at the feeding port, and the width of the constriction part (the neck part) (33) is about 60% to about 95% (typically 70% to 80%) of the width of the narrow path (32) at the discharge port so that pulling and expanding the buffer-forming core can easily and effectively be accomplished. In some embodiments, the neck part (33) can be positioned in the narrow path (32) at the discharge port; however, in that case, the expanded buffer packing material discharged from the discharge port may be retracted back to the inside the discharge port. By forming the neck part near the narrow path, retraction of the expanded buffer packing material can be prevented.

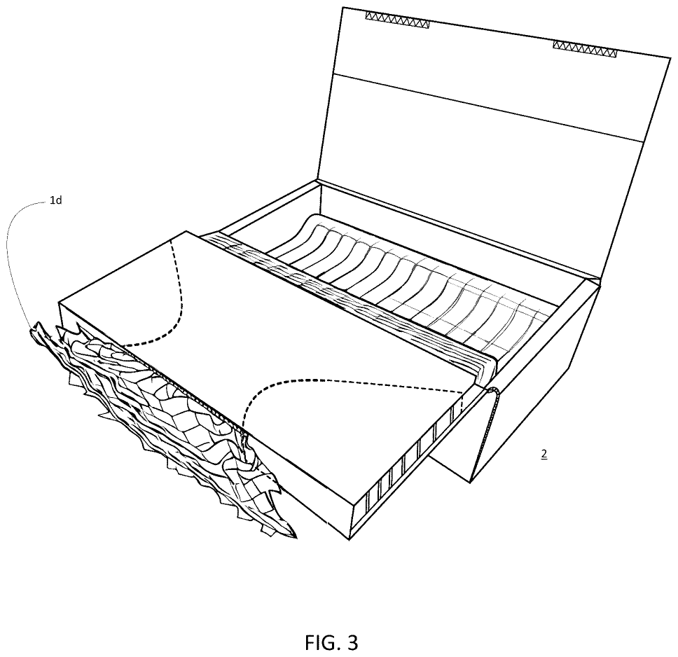

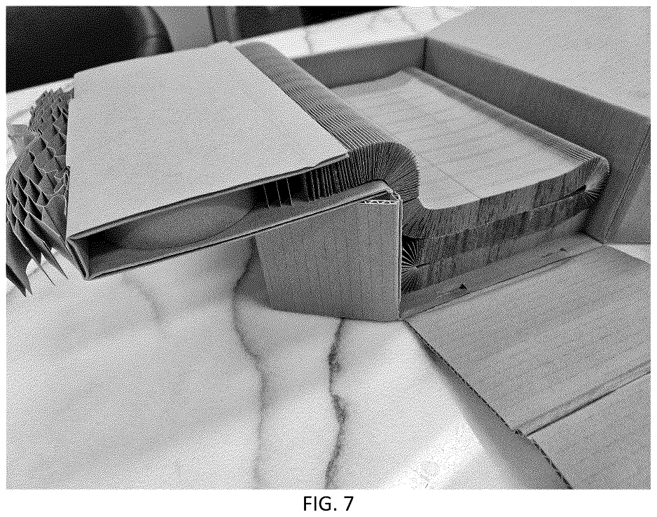

The first aspect includes <9> the package box (2) wherein the belt-shaped sheets (10) are stacked in the direction of the expansion axis (X) in the storage compartment (21), forming a layer (1a), parallel to a bottom (51) of the storage compartment (21), in the conveying direction (X).
<8> of the first aspect includes <10> the package box (2) wherein the layer (1a) is continuous and stored in a serpentine pattern, forming multiple layers in a direction (Z) perpendicular to the bottom (51) of the storage compartment (21). FIG. 7 is an image of the package box corresponding FIG. 3, showing a part of the storage compartment disassembled to reveal the interior where a layer of the stacked sheets of the buffer-forming core is stored in a serpentine pattern.

The first aspect includes <11> the package box (2) wherein the sheets (10) are made of a biodegradable fiber material. Preferably, each of the sheets 10 is cycled paper.

In some embodiments, the expanded buffer-forming core (the buffer packing material) discharged from the discharge port 23 can easily be torn off by fingers or cut off with a knife so that a user can obtain a desired length of the buffer packing material. FIG. 3 is a schematic perspective view of the package box after tearing off a buffer packing material according to an embodiment of the present invention, wherein broken lines indicate the shape of the conveyance path provided in the discharge compartment as viewed from above.

Some embodiments provide as a second aspect:
<12> A package box (2) for storing therein a buffer-forming core (10) for forming a buffer packing material (1c), wherein the buffer-forming core (1, 1a) is composed of a plurality of identical belt-shaped sheets (10) bonded to one another at bonded parts (11a, 11b) of the sheets and is expandable in an expansion axis (X) to form a buffer packing material (1c), wherein the bonded parts (11a. 11b) are positioned so that, at an expanded state, the sheets (10) form roughly hexagonal honeycomb bodies (1e) as viewed in a height direction perpendicular to the expansion axis (X), and
the package box (2) comprises:
a storage compartment (21) in which the belt-shaped sheets (10) are stacked and stored; and
a discharge compartment (22) which is disposed on top of the storage compartment (21) at a closed position as a lid of the storage compartment (21) when in non-use, wherein the discharge compartment (22) pivots on a first rim (41) of the storage compartment (21) and flips by pivoting on the first rim (41) at an open position when in use, said discharge compartment (22) comprising: a feeding port (24) proximal to the first rim (41) for guiding and feeding the buffer-forming core (1a) stored in the storage compartment (21) in a direction of the expansion axis (X); a discharge port (23) distal to the first rim (41), disposed at an edge opposite to the feeding port (24), for outputting the buffer packing material (1c); and a conveyance path (30) for passing the buffer-forming core (1b) therethrough from the feeding port (24) to the discharge port (23) in the direction of the expansion axis (X); wherein
the conveyance path (30) has a constriction part (33) wherein at the open position, by pulling the belt-shaped sheet(s) (10, 10a) at the discharge port (23) out of the discharge port (23), the buffer-forming core (1c), while being conveyed through the conveyance path (30), is expanded through the constriction part in a conveying direction (X) which is the direction of the expansion axis (X) of the buffer-forming core (1c) to form the roughly hexagonal honeycomb bodies (1e).

In the above embodiment, the package box (2) can be reused by loading a new buffer-forming core (1, 1a) in the storage compartment (21) when the buffer-forming core is consumed.

The second aspect includes <13> the package box wherein the conveyance path (30) is defined by an upper plate (27), a lower plate (28), a first side wall (25), and a second side wall (26), wherein the first side wall (25) and the second side wall (26) are shaped in a manner that the conveyance path (30) comprises a wide path (31) proximal to the feeding port (24) and a narrow path (32) proximal to the discharge port (23), said narrow path (23) including the constriction part (33), wherein, in a longitudinal direction of the belt-shaped sheets (10, 10a), a width of the wide path (31) at the feeding port (24) is greater than a width of the narrow path (32) at the discharge port (23), and a width of the constriction part (33) is smallest in the conveyance path (30), i.e., the first and second side walls are shaped so as to have a constriction (a neck part) near the discharge port (23). When the neck part (33) is not formed, the narrow path (32) functions as a constriction part. Due to the constriction part, the buffer-forming core is forcefully expanded in the expansion (conveyance) direction to form a buffer packing material constituted by a honeycomb stricture.

The second aspect includes <14> the package box wherein the storage compartment (21) is a top-less rectangular parallelepiped container, and the discharge compartment (22) acts as a lid of the storage compartment (21) at the closed position and flips by pivoting on the first rim 41) at the open position.

The second aspect includes <15> the package box further comprising an outer lid (29) which is attached to a second rim (42; FIG. 4) of the storage compartment (21) opposite the first rim (41; FIG. 4) at the closed position, and flips by pivoting on the second rim (42) at the open position, wherein the discharge compartment (22) acts as an inner lid, and at the closed position, the package box (2) becomes a rectangular parallelepiped box. Any embodiments disclosed herein in connection with the first aspect can apply to the second aspect.

Some embodiments provide as a third aspect:
<16> A package box (2) containing therein a buffer-forming core (1, 1a) for forming a buffer packing material (1c), wherein the buffer packing material (1c) includes a plurality of identical belt-shaped sheets (10) bonded to one another at bonded parts (11a, 11b) of the sheets (10) and expanded in an expansion axis (X), and the buffer-forming core (1, 1a) is comprised of the plurality of belt-shaped sheets (10) stacked in the expansion axis direction (X), wherein the package box (2) comprises a storage compartment (21) in which the buffer-forming core (1a) is stored, and a discharge compartment (22) which is, at a closed position, disposed on top of the storage compartment (21) and acts as a lid of the storage compartment (21), and flips open to an open position by pivoting on one side (41) of the discharge compartment (22) which is attached to one side (41) of the storage compartment, and the discharge compartment (22) has a feeding port (24) to which the buffer-forming core (1a) is fed from the storage compartment (21), a discharge port (23) from which the buffer packing material (1c) is discharged, and a conveyance path (30) which connects the feeding port (24) and the discharge port (23) and is constituted by a wide path (31) and a narrow path (32) which includes a constriction part (33) through which the buffer-forming core (1b) is expanded in the expansion axis direction (X) to form the buffer packing material (1c), wherein at the open position, the buffer packing material (1c) is pulled out from the discharge port (23), and the discharge compartment (22) flips back to the closed position when in non-use.

The third aspect includes <17> the package box (2) further comprising an outer lid 29) which is attached to another side (42) of the storage compartment (21) opposite to the one side (41) on which the discharge compartment (22) is pivoted, wherein at the closed position, the outer lid (29) is closed so as to form a rectangular parallelepiped box. At a closed position, the package box becomes a rectangular parallelepiped box which is compact and easy to store, ship, carry, and use.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

It will be understood by those of skill in the art that numerous and various modifications can be made without departing from the spirit of the present invention. Therefore, it should be clearly understood that the forms of the present invention are illustrative only and are not intended to limit the scope of the present invention.

1. A package box containing therein a buffer-forming core for forming a buffer packing material, wherein
the buffer-forming core is composed of a plurality of identical belt-shaped sheets bonded to one another at bonded parts of the sheets, and is expandable in an expansion axis to form a buffer packing material, wherein the bonded parts are positioned so that, at an expanded state, the sheets form roughly hexagonal honeycomb bodies as viewed in a height direction perpendicular to the expansion axis, and
the package box comprises:
a storage compartment in which the belt-shaped sheets are stacked and stored; and
a discharge compartment which is disposed on top of the storage compartment at a closed position as a lid of the storage compartment when in non-use, wherein the discharge compartment pivots on a first rim of the storage compartment and flips by pivoting on the first rim at an open position when in use, said discharge compartment comprising: a feeding port proximal to the first rim for guiding and feeding the buffer-forming core stored in the storage compartment in a direction of the expansion axis; a discharge port distal to the first rim, disposed at an edge opposite to the feeding port, for outputting the buffer packing material; and
a conveyance path for passing the buffer-forming core therethrough from the feeding port to the discharge port in the direction of the expansion axis; wherein the conveyance path has a constriction part wherein at the open position, by pulling the belt-shaped sheet(s) at the discharge port out of the discharge port, the buffer-forming core, while being conveyed through the conveyance path, is expanded through the constriction part in a conveying direction which is the direction of the expansion axis of the buffer-forming core to form the roughly hexagonal honeycomb bodies.

2. The package box according to claim 1, wherein the conveyance path is defined by an upper plate, a lower plate, a first side wall, and a second side wall, wherein the first side wall and the second side wall are shaped in a manner that the conveyance path comprises a wide path proximal to the feeding port and a narrow path proximal to the discharge port, said narrow path including the constriction part, wherein, in a longitudinal direction of the belt-shaped sheets, a width of the wide path at the feeding port is greater than a width of the narrow path at the discharge port, and a width of the constriction part is smallest in the conveyance path.

3. The package box according to claim 1, wherein the storage compartment is a top-less rectangular parallelepiped container, and the discharge compartment acts as a lid of the storage compartment at the closed position and flips by pivoting on the first rim at the open position.

4. The package box according to claim 1, further comprising an outer lid which is attached to a second rim of the storage compartment opposite the first rim at the closed position, and flips by pivoting on the second rim at the open position, wherein the discharge compartment acts as an inner lid, and at the closed position, the package box becomes a rectangular parallelepiped box.

5. The package box according to claim 1, wherein the storage compartment and the discharge compartment are made of cardboard.

6. The package box according to claim 1, wherein the storage compartment is made of cardboard, and the discharge compartment is made of plastic.

7. The package box according to claim 1, wherein a distance between the upper plate and the lower plate of the conveyance path corresponds to a height of the buffer-forming core.

8. The package box according to claim 1, wherein the width of the narrow path at the discharge port is about 40% to about 80% of the width of the wide path at the feeding port, and the width of the constriction part is about 60% to about 90% of the width of the narrow path at the discharge port.

9. The package box according to claim 1, wherein the belt-shaped sheets are stacked in the direction of the expansion axis in the storage compartment, forming a layer, parallel to a bottom of the storage compartment, in the conveying direction.

10. The package box according to claim 9, wherein the layer is continuous and stored in a serpentine pattern, forming multiple layers in a direction perpendicular to the bottom of the storage compartment.

11. The package box according to claim 1, wherein the sheets are made of a biodegradable fiber material.

12. A package box for storing therein a buffer-forming core for forming a buffer packing material, wherein
the buffer-forming core is composed of a plurality of identical belt-shaped sheets bonded to one another at bonded parts of the sheets, and is expandable in an expansion axis to form a buffer packing material, wherein the bonded parts are positioned so that, at an expanded state, the sheets form roughly hexagonal honeycomb bodies as viewed in a height direction perpendicular to the expansion axis, and
the package box comprises:
a storage compartment in which the belt-shaped sheets are stacked and stored; and
a discharge compartment which is disposed on top of the storage compartment at a closed position as a lid of the storage compartment when in non-use, wherein the discharge compartment pivots on a first rim of the storage compartment and flips by pivoting on the first rim at an open position when in use, said discharge compartment comprising: a feeding port proximal to the first rim for guiding and feeding the buffer-forming core stored in the storage compartment in a direction of the expansion axis; a discharge port distal to the first rim, disposed at an edge opposite to the feeding port, for outputting the buffer packing material; and
a conveyance path for passing the buffer-forming core therethrough from the feeding port to the discharge port in the direction of the expansion axis; wherein the conveyance path has a constriction part wherein at the open position, by pulling the belt-shaped sheet(s) at the discharge port out of the discharge port, the buffer-forming core, while being conveyed through the conveyance path, is expanded through the constriction part in a conveying direction which is the direction of the expansion axis of the buffer-forming core to form the roughly hexagonal honeycomb bodies.

13. The package box according to claim 12, wherein the conveyance path is defined by an upper plate, a lower plate, a first side wall, and a second side wall, wherein the first side wall and the second side wall are shaped in a manner that the conveyance path comprises a wide path proximal to the feeding port and a narrow path proximal to the discharge port, said narrow path including the constriction part, wherein, in a longitudinal direction of the belt-shaped sheets, a width of the wide path at the feeding port is greater than a width of the narrow path at the discharge port, and a width of the constriction part is smallest in the conveyance path.

14. The package box according to claim 12, wherein the storage compartment is a top-less rectangular parallelepiped container, and the discharge compartment acts as a lid of the storage compartment at the closed position and flips by pivoting on the first rim at the open position.

15. The package box according to claim 12, further comprising an outer lid which is attached to a second rim of the storage compartment opposite the first rim at the closed position, and flips by pivoting on the second rim at the open position, wherein the discharge compartment acts as an inner lid, and at the closed position, the package box becomes a rectangular parallelepiped box.

16. A package box containing therein a buffer-forming core for forming a buffer packing material, wherein the buffer packing material includes a plurality of identical belt-shaped sheets bonded to one another at bonded parts of the sheets and expanded in an expansion axis, and the buffer-forming core is comprised of the plurality of belt-shaped sheets stacked in the expansion axis direction,
wherein the package box comprises a storage compartment in which the buffer-forming core is stored, and a discharge compartment which is, at a closed position, disposed on top of the storage compartment and acts as a lid of the storage compartment, and flips open to an open position by pivoting on one side of the discharge compartment which is attached to one side of the storage compartment, and
the discharge compartment has a feeding port to which the buffer-forming core is fed from the storage compartment, a discharge port from which the buffer packing material is discharged, and a conveyance path which connects the feeding port and the discharge port and is constituted by a wide path and a narrow path which includes a constriction part through which the buffer-forming core is expanded in the expansion axis direction to form the buffer packing material, wherein at the open position, the buffer packing material is pulled out from the discharge port, and the discharge compartment flips back to the closed position when in non-use.

17. The package box according to claim 16, further comprising an outer lid which is attached to another side of the storage compartment opposite to the one side on which the discharge compartment is pivoted, wherein at the closed position, the outer lid is closed so as to form a rectangular parallelepiped box.
